(19) United States
(12) Patent Application Publication
(10) Pub. No.: US 2008/0192247 A1
(43) Pub. Date: Aug. 14, 2008

(54) Optical Probe for Detecting Sers-Active Molecules and Process for its Manufacture

(75) Inventors: Giuseppe Zerbi, San Felice (IT); Andrea Lucotti, Cormano (IT)

Correspondence Address: KING & SPALDING, 1185 AVENUE OF THE AMERICAS, NEW YORK, NY, 10036-4003, US

(73) Assignee: Politecnico di Milano, Milano (IT)

(21) Appl. No.: 11/817,447

(22) PCT Filed: Mar. 13, 2006
(86) PCT No.: PCT/IB06/00543

§ 371 Date: Aug. 30, 2007

(30) Foreign Application Priority Data
Mar. 15, 2005 (IT) MI2005A000422

(51) Int. Cl. G01J 3/44

(52) U.S. Cl. 356/301

(57) ABSTRACT

The invention relates to an optical probe for detecting SERS-active molecules. The probe can transmit incident electromagnetic radiation at a predetermined wavelength and comprises a core and a shell. The core in turn comprises a first tapered portion and a second portion. The second portion is connected to the first tapered portion and is covered at least partially by a coating of SERS-active metallic material. The first portion and the remaining part of the second portion is covered with a coating of an at least partially reflective metallic material. The invention also provides methods for making and using such an optical probe.

### DESCRIPTION

The present invention relates to an optical probe for detecting SERS-active molecules by Raman spectroscopy. The invention also relates to a process for its manufacture, based on static chemical etching.

Raman spectroscopy is a process of structural investigation which is well known in chemical analysis. The spectra obtained generally show narrow and well-resolved vibration bands which represent the structural information relating to the molecules analyzed. However, the intensities involved are generally too low and the probes have poor sensitivity.

Surface-enhanced Raman scattering, also known as SERS can increase the intensity of the Raman spectra by more than six orders of magnitude. The effect, which is thus known as the SERS effect, relates to chemical and electromagnetic mechanisms and can be observed in proximity to metallic surfaces with suitable roughness, with particles such as metal colloids, or even in the presence of nano-particle metallic films.

The document U.S. Pat. No. 5,864,397 describes a probe for a SERS Raman spectrometer which includes an optically transmissive material that can receive excitation radiation and can convey the radiation emitted by a sample to a detector. Specifically, an optical fibre from which the protective coating or the shell has been removed at one end thereof has, at that end, a coating which brings about a surface enhancement of the Raman intensity of the sample during Raman spectroscopic analysis. This coating is described as being formed by a first layer of nano-particles or micro-particles and by a metallic layer on top of the first layer.

An investigation relating to the geometrical shape of the tips in SERS optical-fibre sensors is reported in the document entitled “Single-fibre surface-enhanced Raman sensors with angled tips” (Carmen Viets and Wieland Hill, Journal of Raman Spectroscopy, John Wiley & Sons, Ltd., Mar. 16, 2000, 625-631). The investigation described shows that the SERS intensities of optical-fibre sensor tips can be enhanced by changing the geometrical shape of the sensor tip. For all of the preparation examples, it is described that honing of the tips of the optical-fibre sensors to an angle of inclination of 40° prior to the application of the active SERS layer, specifically Ag/Al₂O₃, can considerably increase the SERS intensity recorded.

Amongst the processes of manufacturing optical-fibre SERS sensors with tips having specific geometrical shapes, static chemical etching has been proposed (C. Viets, W. Hill “Fibre-optic SERS sensors with conically etched tips”, Journal of Molecular Structure, 563-564 (2001) 163-166). In fact, silica fibres having polymer shells and are subjected to chemical etching in hydrofluoric acid are described. According to the teaching of this document, the acid treatment produces a sensor with a conical tip by means of which considerable enhancement of the SERS effect is achieved by virtue of multiple reflections of the radiation at the sensor tip.

Although SERS-effect sensors of the type described above work with greater sensitivity in chemical analysis than normal Raman sensors, there is still a need to detect SERS-active molecules in low concentrations, particularly in fields such as biology, environmental analysis, or even sports medicine.

The object of the present invention is therefore to provide a novel SERS-effect optical probe which has greater sensitivity than known SERS-effect sensors.

A further object of the present invention is to provide a novel probe which can detect SERS-active molecule concentrations of less than 10⁻⁶M.

The above-indicated objects are achieved by means of an optical probe as described in claim 1.

The optical probe for detecting SERS-active molecules can transmit incident electromagnetic radiation at a predetermined wavelength and comprises a core of cross-section S and a shell, wherein such a core in turn comprises:
a first tapered portion, and
a second portion having substantially constant cross-section s and length l,

wherein the second portion is connected to the first tapered portion and is covered at least partially by a SERS-active metallic coating, the said first portion and the remaining part of the said second portion being covered with a coating of an at least partially reflective metallic material, and wherein

the cross-section s of the said second portion is in the range of from 10⁻⁸*S to 0.99*S and the length l of the said second portion is in the range of from 0.01*√S to 10⁵*√S.

Further characteristics and advantages of the invention will become clear from the following detailed description which is given with reference to embodiments of the invention that are provided by way of non-limiting example, and to the appended drawings, in which:

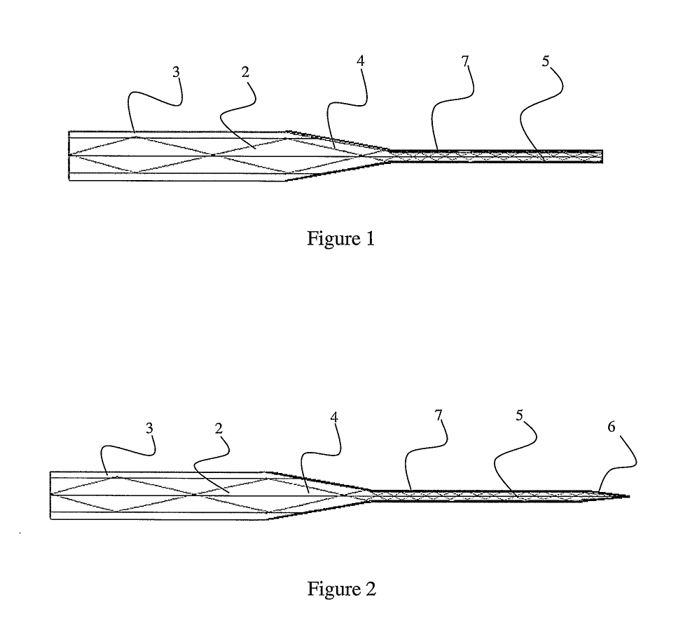

FIG. 1 is a schematic representation of a first embodiment of the optical-fibre optical probe according to the invention;

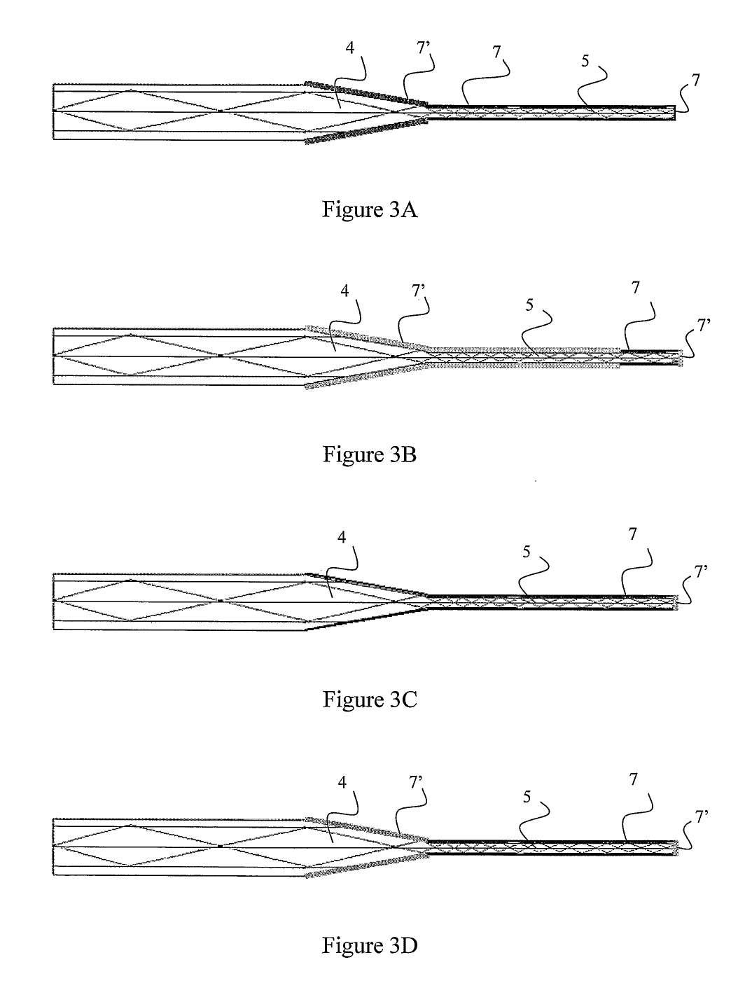

FIG. 2 is a schematic representation of a second embodiment of the optical-fibre optical probe according to the invention;

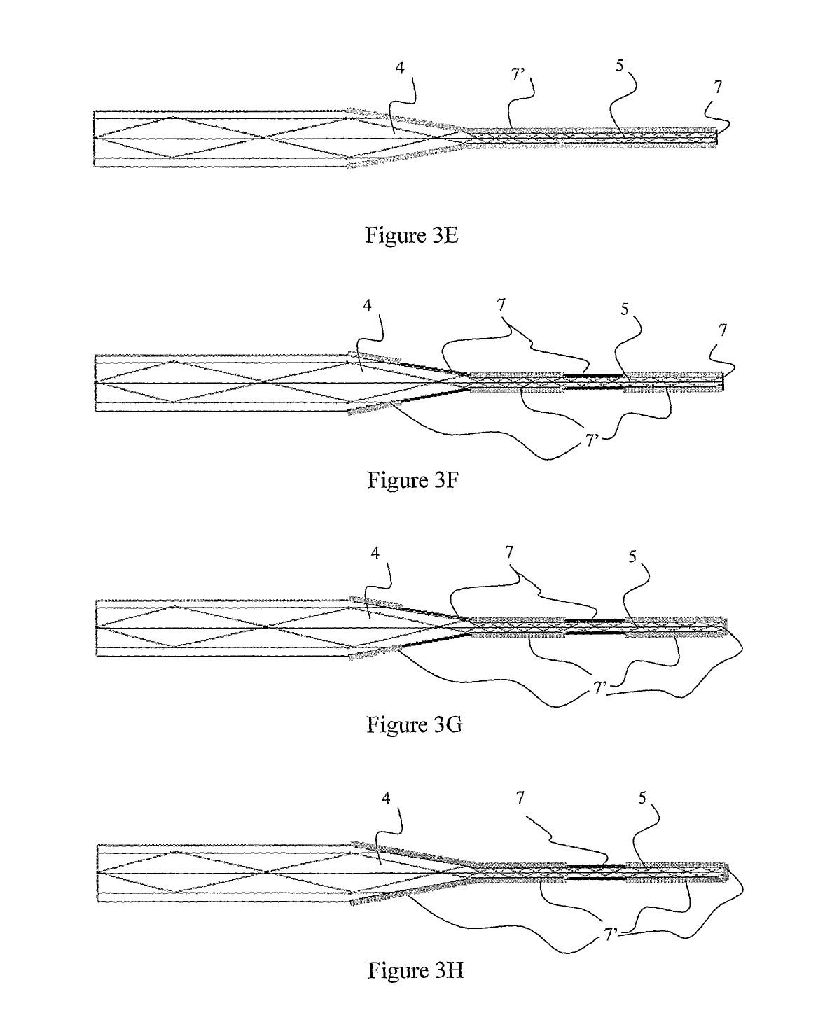

FIGS. 3A-H are schematic representations of further embodiments of the optical-fibre probe according to the invention having a first tapered portion and a second portion of substantially constant cross-section;

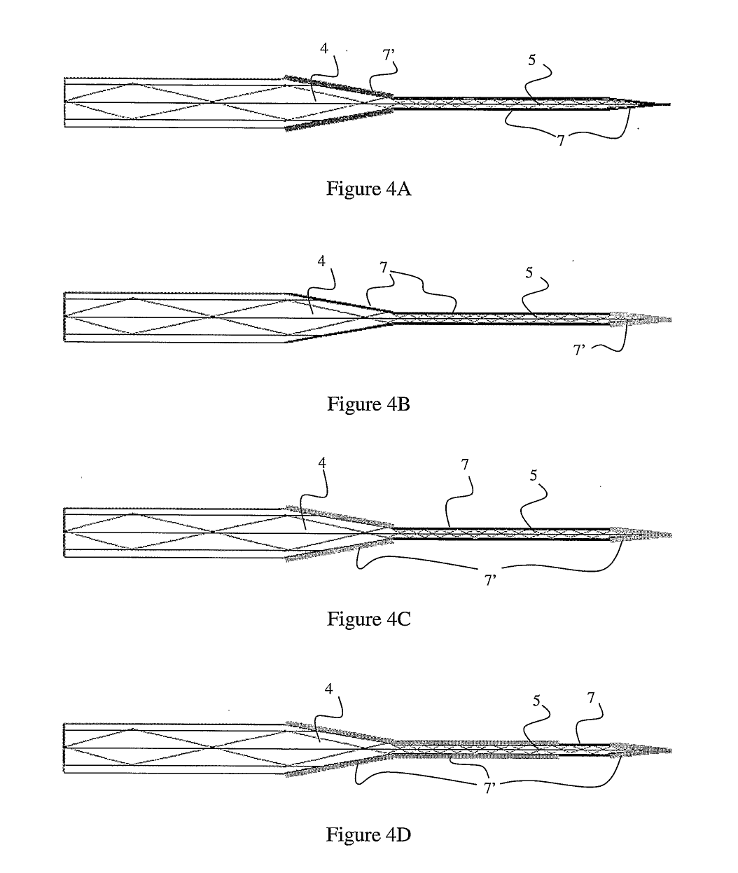

FIGS. 4A-H are schematic representations of further embodiments of the optical-fibre probe according to the invention having a first tapered portion, a second portion of substantially constant cross-section s, and a third tapered portion;

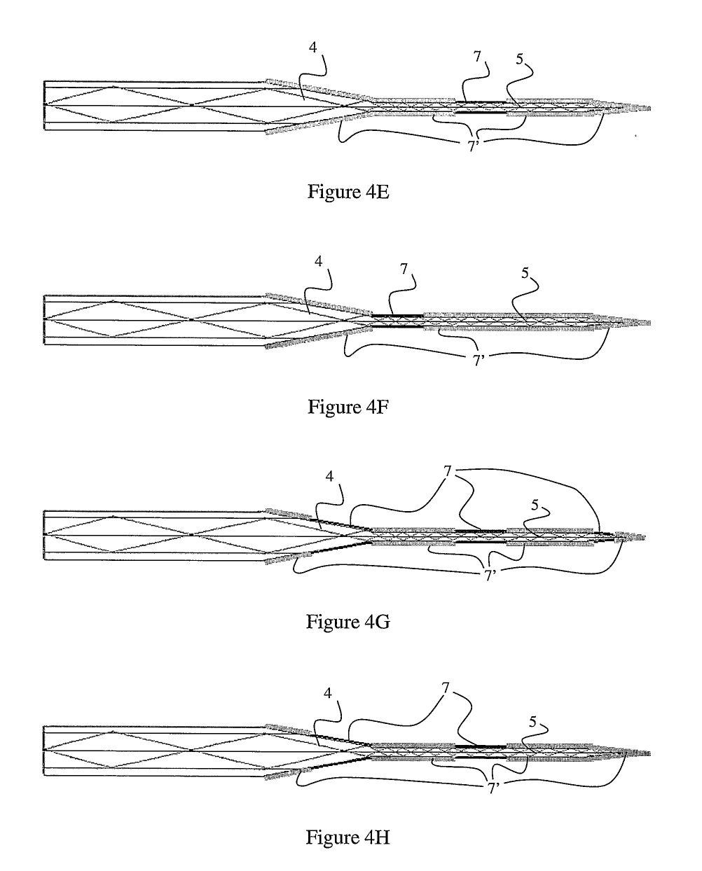

FIG. 5 is a representation of the steps of a first process of manufacturing the first embodiment of the probe according to the invention; and

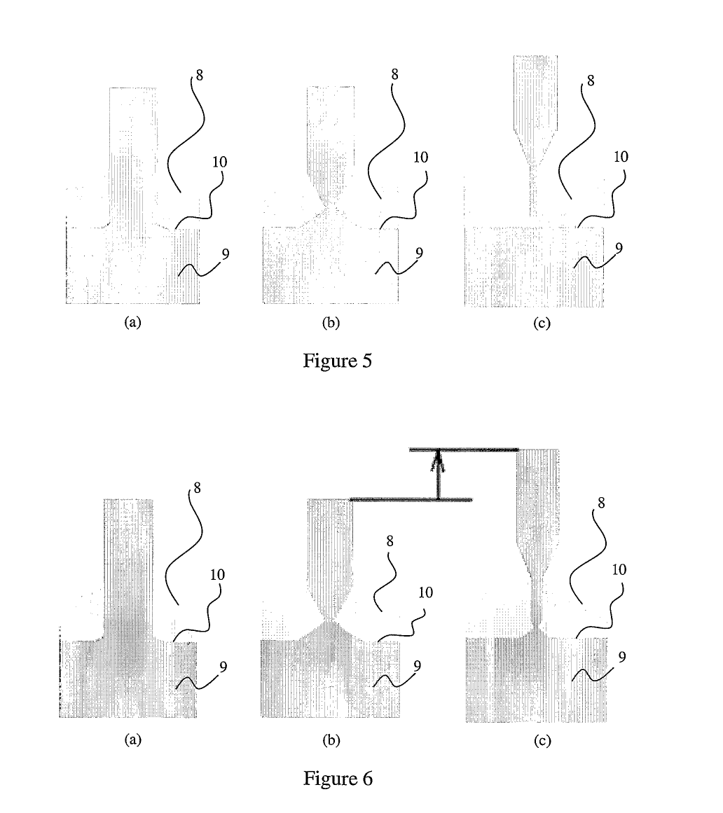

FIG. 6 is a representation of the steps of a process of manufacturing the second embodiment of the probe according to the invention.

When the following terms are used in the present description, they have the meanings given below:

“optical probe” means an optical-fibre or waveguide probe which can convey electromagnetic radiation from the source to the SERS-active molecule and from the SERS-active molecule to the detector;

“etching treatment” means chemical etching performed by a suitable agent;

“SERS molecules” means molecules which show appreciable intensification of the Raman signal when in the presence of nano-structural metals or metallic nano-particles (SERS-active substrates);

“SERS-active metallic coating or SERS-active metallic material” means a metallic coating or material which is at least partially reflective and which can intensify a Raman signal;

“reflective metallic coating or reflective metallic material” means a metallic coating or material which can at least partially reflect the incident radiation, preferably almost completely reflective with respect to the incident radiation.

The probe 1 of the present invention thus comprises a first tapered portion 4 which is connected to a second portion 5 having a substantially constant cross-section s. The second portion 5 of substantially constant cross-section is partially covered with a SERS-active coating 7, the remaining part being covered with at least partially reflective material 7′.

The coating 7 of SERS-active metallic material may be made of any partially reflective metal which can intensify a Raman signal. The SERS-active metal is preferably a metal selected from the group consisting of silver, gold, copper and platinum, even more preferably, it is silver or gold.

The partially reflective metallic coating may be any metal which can at least partially reflect the incident radiation. It is preferably a coating which can reflect the incident radiation substantially completely and is made of aluminium or even of a metal selected from the group consisting of silver, gold, copper and platinum, applied as a coating having a thickness of at least 100 nm, preferably at least 1 μm.

Advantageously and according to a first embodiment shown in FIG. 1, the at least partially reflective metallic material is also a SERS-active metallic material so that substantially the whole of the first portion 4 and substantially the whole of the second portion 5 are covered with a SERS-active metallic coating.

According to the present invention, the first portion 4 and the second portion 5 of the probe may be coated differently as shown in FIGS. 3A-H. Thus, with reference to the embodiment shown in FIG. 3A, the second portion 5 is covered with a coating 7 of SERS-active material and the first portion 4 is covered with a coating 7′ of material that is reflective to the incident radiation. In FIGS. 3B and 3D, part of the second portion 5 is covered with a SERS-active layer 7 and the first portion 4 and the remaining part of the second portion 5 are covered with a coating of reflective metallic material. With reference to the probe shown in FIG. 3C, the first tapered portion 4 is covered with a SERS-active coating 7 which is also present in the second portion 5, solely the end part of the second portion 5 being covered with a coating 7′ of reflective material. Alternatively, in the probes shown in FIGS. 3E and 3H, the first portion 4 and part of the second portion 5 are covered with reflective metallic material 7′, the remaining part of the second portion 5 being covered with a SERS-active material. Finally, the embodiments shown in FIGS. 3F and 3G are characterized by a first portion 4 and a second portion 5 which are covered partially with a coating of SERS-active material, their remaining parts being covered with a coating 7′ of reflective material.

The probe 1 according to the invention may also comprise a third tapered portion 6 which is connected to the second portion 5 which therefore connects the first tapered portion 4 and the third portion 6. In this embodiment, the third portion 6 is also covered with an at least partially reflective metallic material.

The third portion is advantageously at least partially covered with a SERS-active material.

Even more advantageously and with reference to FIG. 2, substantially all of the first portion 4, the second portion 5, and the third portion 6 are covered with a coating 7 of a SERS-active material.

FIGS. 4A-H show optical probes according to the invention comprising the third portion 6. With reference to FIG. 4A, the probe according to the invention comprises the first tapered portion 4 covered with a reflective metallic coating and the second portion 5 and the third portion 6 covered with a SERS-active material. In a further embodiment, as shown in FIG. 4B, the first portion 4 and part of the second portion 5 are covered with a SERS-active material, the third portion 6 and the remaining part of the second portion 5 being covered with a reflective metallic material.

With reference to FIG. 4C, the second portion 5 is substantially completely covered with a SERS-active coating 7, the first portion 4 and the third portion 6 being substantially completely covered with a coating 7′ of a reflective material. In FIGS. 4D, 4E and 4F, the second portion 5 is at least partially covered with a coating 7 of SERS-active material and the remaining part of the second portion 5, the first portion 4, and the third portion 6 are covered with reflective metallic material. In FIGS. 4G and 4H, the first, second and third portions are partially covered with a SERS-active material, their remaining parts being covered with reflective material.

The cross-section s of the second portion is preferably between 10⁻⁶*S and 0.9*S. More preferably, it is between 10⁻⁴*S and 0.3*S.

The length l of the second portion is preferably between 0.1√S and 10⁴*√S. More preferably, it is between √S and 10³*√S.

The optical-fibre probe may comprise a core 2 made of silica (SiO₂) and a shell 3 of silica (SiO₂) or, alternatively, a shell 3 of polymer material and a silica core or even a core 2 and a shell 3 both made of polymer material.

According to the invention, the SERS-active molecules are detected with the use of a laser for emitting electromagnetic radiation and with the use of a Raman spectrometer which permits analysis of the radiation scattered and amplified by the SERS effect due to the presence of the SERS-active molecules.

Whilst it is not wished to be bound to any theory, it is thought that the electromagnetic radiation of the laser used is focused in the core 2 of the optical-fibre probe 1. As the magnetic radiation is propagated within the core 2 of the probe 1, it thus reaches the interface between the core 2 and the SERS-active metallic coating 7 and excites the surface plasmons of the metal of the coating layer 7. It is also thought that this excitation in turn allows the SERS-active molecules to give rise to the SERS effect at the air/metal interface. The radiation, which is scattered by the molecules in an inelastic manner and is kept within the core of the probe owing to the presence of the at least partially reflective coating on the parts, is the radiation which carries intrinsic information on the molecule under analysis. In fact, once this radiation has been collected by the fibre by means of a suitable device, it can be analyzed by means of a Raman spectrometer. Analysis then permits qualitative and quantitative recognition of the SERS molecules.

The optical probe according to the invention therefore advantageously permits the detection of SERS-active molecules. Even more advantageously, the probe according to the invention can detect SERS-active molecules in concentrations of less than 10⁻⁶M. The probe according to the invention permits the detection of SERS-active molecules in low concentrations both in liquid phase and in gaseous phase. Advantageously, in the gaseous phase, the molecules that can be detected by the probe according to the invention are: volatile mercaptans, even if they are only slightly volatile and particularly if they contain π electrons; volatile amines, even if they are only slightly volatile and particularly if they contain π electrons, and aromatic compounds optionally containing one or more heteroatoms such as, for example, pyridine. Advantageously, in this application, the probe can detect molecules in the gaseous phase at concentrations of from parts per thousand down to parts per billion; more advantageously, the probe can detect concentrations of approximately 10⁻² ppb (parts per billion) and is thought to be able to detect concentrations of the order of 10⁻⁵ ppb.

In general, the probe according to the invention can be used for the detection of SERS-active molecules comprising organic, inorganic and metallic substances, optionally in the form of salts or ions.

Most of the organic molecules which possess π electrons and groups for binding to the metallic surface such as, for example, S—H, COOH, C≡C—H, show good intensification. Amongst the classes of SERS-active molecules, nitrogenous bases, neurotransmitters, antibiotics, fungicides, herbicides, cyanides, doping substances, explosive substances, weed-killers, dyes, fertilizers, aromatic compounds, compounds with π bonds, proteins, medicaments, chemotherapeutic medicaments, and amino-acids may be mentioned.

For the qualitative and quantitative determination of the SERS-active molecules when the molecule is in solution as a cation, it may be advantageous to add a salt of an alkali metal or of an alkaline-earth metal such as, for example, sodium chloride, to the solution containing the SERS-active molecule.

Another aspect of the invention relates to a process for manufacturing the first embodiment of the probe, according to claim 16.

The process of manufacturing the probe 1 according to the invention shown in FIG. 1 comprises the following steps:

a) immersing a part of an optical fibre comprising a core 2 having a cross-section S, in a solution comprising an upper solvent phase 8 and a lower etching phase 9, so that the said part of the fibre is immersed below the interface 10 between the upper phase 8 and the lower phase 9;

b) keeping the optical fibre below the said interface 10 until a cross-section s of the immersed part of the fibre is reached by chemical etching performed by the lower etching phase 9;

c) raising a desired length l of the fibre or wave guide above the interface 10; and

d) applying a coating of SERS-active metallic material to the parts that were subjected to chemical etching in step b).

Advantageously, this process according to the invention provides for a further step which takes place prior to the coating of the part subjected to the etching to obtain a probe according to the second embodiment of the invention. Specifically, a process of manufacturing a probe shown in FIG. 2, according to claim 17, is also described. This process comprises the following steps:

a) immersing a part of an optical fibre comprising a core 2 having a cross-section S in a solution comprising an upper solvent phase 8 and a lower etching phase 9 so that the said part of the fibre is below the interface 10 between the upper phase 8 and the lower phase 9;

b) keeping the optical fibre below the interface 10 until a cross-section s of the immersed part of the fibre is reached by chemical etching performed by the lower etching phase 9;

c) raising a desired length l of the fibre above the interface 10, whilst keeping the end part of the fibre below the interface 10 between the upper phase 8 and the lower phase 9 so that the said end part is subjected to chemical etching by the lower etching phase 9; and

d) applying a coating of SERS-active metallic material to the parts that were subjected to chemical etching treatment in steps b) and c).

Alternatively, according to the invention, a probe according to the first embodiment may be produced by the process according to claim 17 when that process comprises a further step e) consisting of the removal of the end part of the fibre that was treated with the lower etching phase 9 in step c).

With reference to FIG. 5, in step a), an optical fibre with a core 2 is partially immersed in a container to which a lower phase 9, which is a solution suitable for performing chemical etching, and an upper phase 8, which is a protective solvent layer, have previously been added.

The lower etching phase 9 is chemically reactive with the fibre core 2, whereas the upper solvent phase 8 is substantially inert with respect to the fibre. The lower phase 9 and the upper phase 8 are therefore preferably two liquids which are substantially immiscible with one another and which form an interface 10 in the region of the upper surface of the lower etching phase 9.

The density of the lower etching phase 9 is substantially greater than that of the upper phase 8 to ensure that the etching liquid is in the lower portion of the container.

The fibre immersed in step a) is then kept static in step b). In this step, the chemical etching process therefore takes place for the part of the fibre that is below the interface 10 between the upper phase 8 and the lower phase 9. This chemical etching process takes place by means of the lower etching phase 9 and for a period of time necessary to reduce the cross-section of the original fibre to a desired cross-section s which is within the range of between 10⁻⁸*S and 0.99*S. With reference to FIG. 5, in step b), the interface 10 between the lower phase 9 and the upper phase 8 is modified to form a meniscus in the region of the fibre such that, in the part corresponding to the meniscus, the chemical etching performed on the fibre by the etching phase 9 produces a first portion of tapered shape.

When the desired cross-section s of the fibre below the interface 10 between the upper phase 8 and the lower phase 9 has been reached, a length l of the fibre is raised out of the lower phase 9 as shown in FIG. 5 for step c). The length l will be between 0.01√S and 10⁵*√S, preferably between 0.1√S and 10⁴*√S, even more preferably between √S and 10³*√S.

The fibre thus produced in step c) will therefore be formed by a first tapered portion 4 and by a second portion 5 of substantially constant cross-section s and length l.

With reference now to FIG. 6, an optical fibre is immersed and subjected to steps a) and b) exactly as indicated above with reference to FIG. 5. In step c), a desired length l of the fibre is raised but the end part of the fibre is left below the interface 10 between the upper phase 8 and the lower phase 9. At this interface 10, the lower phase 9 is modified to form a meniscus and, for the part of the fibre that is still in contact with the etching solution, a chemical etching process therefore starts which leads to the formation of a tapered end part of the fibre. The probe emerging from step c) will therefore have a first tapered portion 4, a second portion 5 of substantially constant cross-section, and a third tapered portion 6.

The fibre used according to the invention in the two processes described above is preferably a fibre in which the core 2 is made of SiO₂. Even more preferably, the shell 3 of the fibre is also made of SiO₂. In this case, the chemical etching below the interface 10 between the upper phase 8 and the lower phase 9 takes place by means of an acid solution, for example, of hydrofluoric acid, which can chemically etch both the core 2 and the shell 3 and the fibre is therefore immersed in the above-mentioned solution complete with its shell. Alternatively, the fibre used according to the invention may be a fibre with a silica core 2 and a polymer shell 3. In this case, if an acid lower phase 9 is used, the polymer shell will be inert to the chemical etching and will therefore be removed beforehand from the part of the fibre which will be immersed in the acid lower phase 9.

Naturally, the lower etching phase 9 may be selected appropriately so as to perform the chemical etching also for fibres constituted by a core and a shell of polymer material.

The upper solvent phase 8 may be any solvent that is substantially immiscible with and of lower density than the etching phase. When the lower phase is an acid etching phase, the solvent will preferably be selected from the group consisting of iso-octane, p-xylene, m-xylene, dodecyl mercaptan, octane, toluene, 1-chloro-octane, dibutyl sulphide, dibutyl ether.

The fibre subjected to chemical etching in step c) is then coated in step d). The coating step for the two processes of manufacturing the first and second embodiments of the probe according to the invention can be performed by all of the known techniques for the deposition of metallic layers since the first and second portions 4 and 5 for the process of claim 16 and the first, second and third portions 4, 5, and 6 for the process of claim 17 are all coated solely with the SERS-active material. In particular, according to the present invention, the SERS-active metallic coating may be applied by vacuum plating, by the use of a solution of a salt of the metal and subsequent heating, or by deposition of a layer of nano-particles. Preferably, the metal deposited is silver or gold, even more preferably, it is silver. For a silver coating, the application will take place by coating with a solution of silver hexanoate and subsequent heating to a temperature greater than 250° C. or by the formation of a layer of nano-particles by means of a colloidal silver solution and immobilization with a suitable immobilizing agent, for example, a compound selected from the group consisting of (3-aminopropyl)-trimethoxysilane, (3-aminopropyl)-triethoxysilane, (3-chloropropyl)-trimethoxysilane, (3-chloropropyl)-triethoxysilane, (3-mercaptopropyl)-trimethoxysilane, and (3-mercaptopropyl)-triethoxysilane. It is preferably (3-aminopropyl)-trimethoxysilane.

In one particular embodiment of the invention, the coating of SERS-active metallic material is produced by the immersion of the fibre in a colloidal solution of metal nano-particles and polyvinyl alcohol. The metallic nano-particle coating 7 obtained will thus be a coating of metal nano-particles dispersed in a polyvinyl alcohol film.

For gold coating, the coating will preferably be applied by the formation of a layer of nano-particles by means of a colloidal gold solution or by means of a colloidal solution in which the particles have a silver core and a gold shell and are produced separately and then immobilized or are produced by immersing the fibre with silver nano-particles in a solution of a gold salt.

Amongst the above-described applications of coatings, the application of the coating by the deposition and immobilization of SERS-active metal nano-particles has been found advantageous and will therefore be preferred as the application in the processes according to the invention.

The processes detailed above relate to the two embodiments which provide for the first portion 4, the second portion 5 and, in the case of the process of claim 17, the third portion 6, to be covered substantially entirely with a SERS-active coating but a person skilled in the art will be able to arrange for modifications in the coating application step d) to permit coating partially with SERS-active material and partially with partially reflective material. For example, once the chemical etching has been performed exactly as indicated above in steps a), b) and c) of the processes of claims 16 and 17 to produce the desired geometrical shape of the probe (with or without the third tapered portion 6), a first application of a reflective coating of a metal such as silver or gold may be arranged by the deposition of a coating layer of about 1 μm thickness. This step may be followed by a chemical treatment step for removing that coating solely from the parts of the various portions in which a coating of SERS-active material is desired and then by a second application of a coating of SERS-active material. This coating will take place on the parts of the portions just treated chemically, for example, by an application of a layer of silver nano-particles by their immobilization with (3-aminopropyl)-trimethoxysilane.

Step d) of the application of a SERS-active coating may take place after the production of the probe or may take place at the time of use, either before or during the detection and measurement of the SERS-active molecules.

Although step d) of the application of the SERS-active coating takes place on the parts that have been subjected to chemical etching, that is, the parts of step b) for the process of claim 16 and of steps b) and c) for the process of claim 17, it may also be performed on the parts that were not subjected to chemical etching without modifying the results of the invention.

The probe according to the invention may also advantageously be covered with a further layer (a single layer or several molecular layers) on top of the coating of SERS-active material. This further layer has the purpose of binding the SERS-active molecules, for example, by physisorption or induced dipole-induced dipole interactions, and hence of not permitting excessive adhesion of the molecules to the coating of SERS-active material, by acting as a separator layer. This facilitates washing operations between one measurement and the next.

This further layer may advantageously be a layer for functionalizing the SERS-active metallic coating to permit the detection of molecules which, although they have poor affinity for the SERS-active coating, have an affinity for the functionalizing layer. SERS substrates can be functionalized by alkyl mercaptans (K. Carron, L. Peltersen, M. Lewis. Environ. Sci. Technol., 26, 1950, 1992; K. Mullen, K. Carron, Anal. Chem., 1994, 66, 478-483), dimercaptans and diamines, in order to utilize the functional groups that are not bound by the metal to interact more or less selectively with any analytical or “target” molecules, or even by molecules which themselves are “SERS-active”, such as, for example, aromatic mercaptans (P. A. Mosier-Boss, S. H. Lieberma, Analitica Chimica Acta, 2003, 488, 15-23; K. I. Mullen, DX. Wang, L. G. Crane and K. T. Karron, Anal. Chem. 1992, 64, 930-936), polyines or more complex molecules (L. G. Crane, D. Wang, L. M. Sears, B. Heyns and K. Carron, Anal. Chem. 1995, 67, 360-364) which can modify their own SERS spectrum by interaction with the analyte (with the formation of covalent, ionic, hydrogen, or Van der Waals or London bonds) or upon variation of the environmental conditions (pH (K. I. Mullen, DX. Wang, L. G. Crane and K. T. Karron. Anal., Chem., 1992, 64 930-936), dielectric constant of the medium, redox activity of the medium, etc.). Finally, SERS-active coatings can also be functionalized with DNA sequences or fragments of sequences for use in genomics (T. Vo-Dinh, D. L. Stokes, G. D. Griffin, M. Volkan, U. J. Kim and M. I. Simon, J. Raman Spectrosc., 1999, 30, 785-793).

When the probe according to the invention has the functionalizing layer it therefore permits the detection of molecules with poor affinity for the SERS-active layer.

The probe according to the invention is cut at the end remote from the coated end, preferably so as to produce a cross-section with a perpendicular parallel to the axis of the fibre, and is used thus for the detection of the SERS molecules.

During use, the electromagnetic radiation of a laser is focused, by means of the optics of a microscope or other focusing system, in the core of the probe whilst the probe is kept coaxial with the axis of the optical focusing system (the axis of the lens).

The Raman spectrometer used may be any Raman device, even a portable device.

The invention will now be described with reference to an example of the production of the probe and to its use in the detection of the Rhodamine 6G molecule and the Crystal Violet molecule which are well-known to be SERS-active molecules.

### EXAMPLE 1

### Preparation of the Fibre

An optical fibre with a silica core and a silica shell, with the protective layer removed and having NA=0.22 and a core diameter of 180 μm was immersed in a polyethylene container of about 4 cm height and 1 cm diameter. The container contained a 40% aqueous solution of HF beneath a layer of toluene. The optical fibre was then kept stationary for about 80 minutes to bring about a reduction of the fibre diameter to 15 μm. Chemical etching of the fibre took place at the interface 10 between the aqueous HF solution and toluene, forming a frusto-conical surface. When the 80 minutes had elapsed, the fibre was raised out of the acid by 1 cm and kept thus for about 10-15 minutes. The end part of the fibre, which was still immersed in the acid, was kept thus for a further 10-15 minutes and, after chemical etching for a total of 20-30 minutes in the partially raised, second position, the end part of the fibre had adopted a conical shape and the fibre was withdrawn and subjected to a silver-coating treatment.

### EXAMPLE 2

### Silver-Coating of the Fibre

A fibre as obtained in Example 1 was subjected to a coating step. The coating step was performed in accordance with various silver-deposition techniques as detailed in Examples 2A-2I below.

2A) Coating with Silver Hexanoate

The part of the optical fibre that had been subjected to chemical etching was positioned on a hot plate (T>250-300° C.) and a few drops of a saturated solution of silver hexanoate in xylene were poured onto it. Rapid evaporation of the xylene led to the formation of a silver hexanoate film which was rapidly transformed into a silver film by thermal reduction. The tip thus coated was then washed with xylene.

2B) Coating with a Layer of Silver Nano-Particles

The part of the fibre that had been subjected to the acid treatment of Example 1 was immersed for 10 minutes in a solution containing 4 parts of H₂SO₄ and 1 part of 30% H₂O₂ at 60° C. Once it had been removed from this solution, the part was washed with ethanol and water and dried and then immersed in a 1-5% solution of (3-aminopropyl)-trimethoxysilane in toluene. The solution was kept at boiling point for 1-10 hours. The tip was then removed and washed with toluene and ethanol and dried. The fibre was then immersed in a colloidal silver solution (produced by Lee and Meisel's method and then concentrated) for 1-3 hours and was then removed and washed with water.

Lee and Meisel's conventional method for the production of silver nano-particles comprises the following steps:

1. 100 ml of a 10⁻³ M solution of silver nitrate AgNO₃ in deionized water is prepared;

2. 4 ml of a 1% solution of trisodium citrate in deionized water is prepared;

3. the AgNO₃ solution is heated to boiling point in a container with magnetic stirrer,

4. the solution of step 2 is added when both are at boiling point,

5. boiling and mechanical stirring of the solution are continued for 1 hour,

6. the solution is cooled and stirring is continued until cooling is complete.

2C) Coating with a Layer of Silver Nano-Particles

The part of the fibre which had been subjected to the acid treatment of Example 1 was immersed for 10 minutes in a solution containing 4 parts of H₂SO₄ and 1 part of 30% H₂O₂ at 50° C. Once the part had been removed from this solution, it was washed with ethanol and water and dried and then immersed in a 1-10% solution of (3-aminopropyl)-trimethoxysilane in methanol for 12-36 hours. The tip was then removed and washed with abundant methanol and dried. The fibre was then immersed in a colloidal silver solution (produced by Lee and Meisel's method and then concentrated) for 12-36 hours and then removed and washed with water.

2D) Coating with a Layer of Silver Nano-Particles

The part of the fibre which had been subjected to the acid treatment of Example 1 was immersed for 10 minutes in a solution containing 4 parts of H₂SO₄ and 1 part of 30% H₂O₂ at 60° C. Once the part had been removed from this solution, it was washed with water and then with ethanol. It was then immersed in a 10-30% solution of (3-aminopropyl)-trimethoxysilane in ethanol for 1-6 hours. The tip was then removed and washed with abundant ethanol and dried. The fibre was then immersed in a colloidal silver solution (produced by Lee and Meisel's method and then concentrated) for 2-12 hours and then removed and washed with water.

2E) Coating with a Layer of Silver Nano-Particles

The part of the fibre which had been subjected to the acid treatment of Example 1 was immersed for 10 minutes in a solution containing 4 parts of H₂SO₄ and 1 part of 30% H₂O₂ at 60° C. Once the tip had been removed from the solution, it was washed with methanol and water. It was then immersed in a 20% by volume solution of (3-aminopropyl)-trimethoxysilane in methanol for 24 hours. Once the tip had been removed from the solution, it was washed with abundant methanol and left to dry for 24 hours at room temperature or for 15-20 minutes at 100-120° C. before being washed again with methanol and distilled water. The fibre was then immersed in the colloidal silver solution (produced by Lee and Meisel's method and then concentrated) for 24-36 hours and then removed and washed carefully with distilled water.

2F) Coating with a Layer of Silver Nano-Particles

The part of the fibre which had been subjected to the acid treatment of Example 1 was immersed for 10 minutes in a solution containing 4 parts of H₂SO₄ and 1 part of 30% H₂O₂ at 60° C. Once the tip had been removed from the solution, it was washed with methanol and water. It was then immersed in a solution containing 2% by volume of (3-aminopropyl)-trimethoxysilane, 5% of distilled water, and 93% of ethanol with stirring for 10 minutes. Once the tip had been removed from the solution, it was washed with abundant ethanol and left to dry for 24 hours at room temperature or for 15-20 minutes at 100-120° C. before being washed again with methanol and distilled water. The fibre was then immersed in the colloidal silver solution (produced by Lee and Meisel's method and then concentrated) for 24-36 hours and then removed and washed carefully with distilled water.

2G) Coating with a Layer of Silver Nano-Particles

The part of the fibre which had been subjected to the acid treatment of Example 1 was immersed for 10 minutes in a solution containing 4 parts of H₂SO₄ and 1 part of 30% H₂O₂ at 60° C. Once the tip had been removed from the solution, it was washed with methanol and water. It was then immersed in a solution containing 5% by volume of (3-aminopropyl)-trimethoxysilane, 5% of distilled water and 90% of ethanol with stirring for 1 hour. Once the tip had been removed, it was washed with abundant ethanol and left to dry for 30 minutes at 80° C. before being washed again with methanol and distilled water. The fibre was then immersed in the colloidal silver solution (produced by Lee and Meisel's method and then concentrated) for 24 hours and then removed and washed carefully with distilled water.

2H) Coating with a Layer of Silver Nano-Particles

The part of the fibre which had been subjected to the acid treatment of Example 1 was immersed for 10 minutes in a solution containing 4 parts of H₂SO₄ and 1 part of 30% H₂O₂ at 60° C. Once the tip had been removed from the solution, it was washed with ethanol and water. It was then immersed in a solution containing 5% by volume of (3-aminopropyl)-trimethoxysilane, 5% of distilled water and 90% of ethanol with mechanical stirring for 1 hour. Once the tip had been removed, it was washed with abundant ethanol and left to dry for 45 minutes at 100° C. before being washed again with ethanol and distilled water. The fibre was then immersed in the colloidal silver solution (produced by a modified Lee and Meisel's method) for a period of time variable from a minimum of 80 hours to a maximum of 120 hours and then removed and kept in a solution of distilled water and very dilute nano-particles until its use.

The modified Lee and Meisel's method for the production of silver nano-particles in aqueous solution comprises the following steps:

1. 200 ml of a 5*10⁻³ M solution of silver nitrate AgNO₃ in deionized water is prepared,

2. 5 ml of a 1% solution of trisodium citrate in deionized water is prepared,

3. the AgNO₃ solution is heated to boiling point in a container with magnetic stirrer,

4. the solution of step 2 is added when both are at boiling point,

5. the solution is kept at about 90° C. with mechanical stirring for 90 minutes,

6. the solution is cooled and stirring is continued until cooling is completed.

Coating of the fibre with a SERS-active substrate.

### 2I) Coating With a Layer of Silver Nano-Particles Dispersed in Polyvinyl Alcohol

The part of the fibre which had been subjected to the acid treatment of Example 1 was washed carefully with acetone and dried. An aqueous solution of silver nano-particles produced by the modified Lee and Meisel's method, to which the polyvinyl alcohol had been added, was then taken and the end of the fibre was immersed in this solution for 10 seconds. After this, the fibre was removed and left to dry freely in air for 10 minutes.

### EXAMPLE 3

### Detection of Rhodamine 6G in Various Concentrations by Means of the Probe of Example 2A

The end of the probe remote from the end that was coated in accordance with Example 2A was cut to produce a cross-section with a perpendicular parallel to the axis of the fibre. The probe was then connected to an argon-ion laser with a 514 nm exciter line and 10 mW power input to the fibre. The electromagnetic radiation emitted by the laser was then focused within the core of the probe by means of a 10× NA=0.25 lens of an Olympus® microscope. The probe was kept coaxial with the lens and at a suitable distance therefrom by a suitable support connected to the microscope sample-holder which had x, y and z adjustability with micrometric movements.

The probe was then immersed in a first Rhodamine test solution of a known concentration of 6*10⁻⁶M and the scattered radiation was collected by a Dilor XY® Raman spectrometer. The spectrum acquired with an accumulation time of 120 seconds also contained the signals typical of the fibre. The Raman spectrum of the fibre was therefore subtracted and the spectrum characteristic of the Rhodamine 6G molecule at that concentration was obtained.

The probe was then immersed in a second Rhodamine 6G test solution of a known concentration of 3*10⁻⁷M and the scattered radiation was again collected by the Dilor XY® Raman spectrometer. The graph obtained by subtraction of the fibre corresponded to the 3*10⁻⁷M Rhodamine concentration.

The probe was again immersed in a third aqueous Rhodamine test solution with a known Rhodamine 6G concentration of 1*10⁻⁶M and methanol at a concentration of 1M and the radiation scattered was collected by the Dilor XY® Raman spectrometer. The spectrum obtained by subtraction of that relating to the fibre was the spectrum of Rhodamine 6G which was detected in spite of the fact that methanol was present at 1M concentration.

### EXAMPLE 4

### Detection of Rhodamine 6G by Means of the Probe of Example 2G

The end of the probe remote from the coated end was cut to produce a cross-section with a perpendicular parallel to the axis of the fibre. The probe was then connected to an argon-ion laser with a 514 nm exciter line and 30 mW power input to the fibre. The electromagnetic radiation emitted by the laser was then focused within the core of the probe by means of a 10× NA=0.25 lens of an Olympus® microscope. The probe was kept coaxial with the lens and at a suitable distance therefrom by a suitable support connected to the microscope sample-holder which had x, y and z adjustability with micrometric movements.

The probe was then immersed in a first 6*10⁻⁸M (moles/litre) test solution of Rhodamine in water and then removed. The radiation scattered with the tip removed was collected by the Dilor XY® Raman spectrometer. The spectrum acquired with an accumulation time of 60 seconds also contained the signals typical of the fibre. The Raman spectrum of the fibre was therefore subtracted and the spectrum characteristic of the Rhodamine 6G molecule was obtained.

### EXAMPLE 5

### Detection of the Crystal Violet Molecule by Means of the Probe of Example 2G

A probe prepared exactly as in Example 2G, with the same exciter line and the same laser power (40 mW) input to the fibre was immersed in a 4*10⁻⁸M (moles/litre) test solution of Crystal Violet in water and then removed. The radiation scattered with the tip removed was collected by the Dilor XY® Raman spectrometer. The spectrum acquired with an accumulation time of 60 sec also contained the signals typical of the fibre. The Raman spectrum of the fibre was therefore subtracted and the spectrum characteristic of the Crystal Violet molecule was thus obtained. In this case, the Crystal Violet spectrum was also visible with the tip immersed.

### EXAMPLE 6

### Detection of the Crystal Violet Molecule by Means of the Probe of Example 2H

The end of the probe remote from the coated end was cut to produce a cross-section with a perpendicular parallel to the axis of the fibre. The probe was then connected to an argon-ion laser with a 514 nm exciter line and 20 mW laser power input to the fibre. The electromagnetic radiation emitted by the laser was then focused within the core of the probe by means of a 10× NA=0.25 lens of an Olympus® microscope. The probe was kept coaxial with the lens and at a suitable distance therefrom by a suitable support connected to the microscope sample-holder which had x, y and z adjustability with micrometric movements.

The probe was then immersed in a first 1*10⁻⁶M (moles/litre) test solution of Crystal Violet in distilled water and the radiation scattered was collected by the Dilor XY® Raman spectrometer with the use of an accumulation time of 10 seconds. The tip was removed and the radiation scattered with the tip removed was then collected by the Dilor XY® Raman spectrometer.

### EXAMPLE 7

### Detection of the Crystal Violet Molecule by Means of the Probe of Example 2H

A probe was prepared exactly as in Example 2H in the same conditions as in Example 6 and, with the use of the same exciter line, the same laser power (20 mW) input to the fibre and the same accumulation time (10s), was immersed in a 1*10⁻⁹M (moles/litre) test solution of Crystal Violet in distilled water and the radiation scattered was collected by the Dilor XY® Raman spectrometer. The tip was then removed and the radiation scattered with the tip removed was collected by the Dilor XY® Raman spectrometer.

### EXAMPLE 8

Detection of the Crystal Violet Molecule with the Aid of NaCl by Means of the Probe of Example 2H

A probe was prepared exactly as in Example 2H in the same conditions as in Example 6 and, with the use of the same exciter line, the same laser power (20 mW) input to the fibre and the same accumulation time (10s), was then immersed in a 1*10⁻¹⁰M (moles/litre) test solution of Crystal Violet in water saturated with NaCl and the radiation scattered was collected by the Dilor XY® Raman spectrometer. The tip was then removed and the radiation scattered with the tip removed was collected by the Dilor XY® Raman spectrometer.

### EXAMPLE 9

### Detection of the Malachite Green Molecule by Means of the Probe of Example 2H

The end of the probe remote from the coated end was cut to produce a cross-section with a perpendicular parallel to the axis of the fibre. The probe was then connected to an argon-ion laser with a 514 nm exciter line and 20 mW laser power input to the fibre. The electromagnetic radiation emitted by the laser was then focused within the core of the probe by means of a 10× NA=0.25 lens of an Olympus® microscope. The probe was kept coaxial with the lens and at a suitable distance therefrom by a suitable support connected to the microscope sample-holder which had x, y and z adjustability with micrometric movements.

The probe was then immersed in a 1*10⁻⁶M (moles/litre) test solution of Malachite Green in distilled water and the radiation scattered was collected by the Dilor XY® Raman spectrometer with the use of an accumulation time of 10 seconds. The tip was then removed and the radiation scattered with the tip removed was collected by the Dilor XY® Raman spectrometer.

### EXAMPLE 10

### Detection of the Rhodamine B Molecule by Means of the Probe of Example 2H

The end of the probe remote from the coated end was cut to produce a cross-section with a perpendicular parallel to the axis of the fibre. The probe was then connected to an argon-ion laser with a 514 nm exciter line and 20 mW laser power input to the fibre. The electromagnetic radiation emitted by the laser was then focused within the core of the probe by means of a 10× NA=0.25 lens of an Olympus® microscope. The probe was kept coaxial with the lens and at a suitable distance therefrom by a suitable support connected to the microscope sample-holder which had x, y and z adjustability with micrometric movements.

The probe was then immersed in a 1*10⁻⁶M (moles/litre) test solution of Rhodamine B in distilled water and was removed after an immersion time of 2 minutes; after a waiting period of 3 minutes to allow the solvent to evaporate, the radiation scattered with the tip removed was collected by the Dilor XY® Raman spectrometer with an accumulation time of 30 seconds.

### EXAMPLE 11

### Detection of the Brilliant Cresyl Blue Molecule by Means of the Probe of Example 2I

The end of the probe remote from the coated end was cut to produce a cross-section with a perpendicular parallel to the axis of the fibre. The probe was then connected to an argon-ion laser with a 514 nm exciter line and 20 mW laser input power. The electromagnetic radiation emitted by the laser was then focused within the core of the probe by means of a 10× NA=0.25 lens of an Olympus® microscope. The probe was kept coaxial with the lens and at a suitable distance therefrom by a suitable support connected to the microscope sample-holder which had x, y and z adjustability with micrometric movements.

The probe was then immersed in a 1*10⁻⁶M (moles/litre) test solution of Brilliant Cresyl Blue in distilled water and was removed after an immersion time of 30 seconds; after a waiting period of 1 minute, the radiation scattered with the tip removed was collected by the Dilor XY® Raman spectrometer with an accumulation time of 15 seconds. The radiation scattered was also collected with waiting periods of 2, 5 and 10 minutes after removal, with an accumulation time of 15 seconds.

### EXAMPLE 12

### Detection of the Crystal Violet Molecule by Means of the Probe of Example 2I

The end of the probe remote from the coated end was cut to produce a cross-section with a perpendicular parallel to the axis of the fibre. The probe was then connected to an argon-ion laser with a 514 nm exciter line and 20 mW laser power input to the fibre. The electromagnetic radiation emitted by the laser was then focused within the core of the probe by means of a 10× NA=0.25 lens of an Olympus® microscope. The probe was kept coaxial with the lens and at a suitable distance therefrom by a suitable support connected to the microscope sample-holder which had x, y and z adjustability with micrometric movements.

The probe was then immersed in a 1*10⁻⁸M (moles/litre) test solution of Crystal Violet in distilled water and was removed after an immersion time of 30 seconds; after a waiting period of 1 minute, the radiation scattered with the tip removed was collected by the Dilor XY® Raman spectrometer with an accumulation time of 15 seconds. The radiation scattered was also collected with waiting periods of 2, 5 and 10 minutes after removal.

### EXAMPLE 13

### Detection of the Crystal Violet Molecule by Means of the Probe of Example 2I

The end of the probe remote from the coated end was cut to produce a cross-section with a perpendicular parallel to the axis of the fibre. The probe was then connected to an argon-ion laser with a 514 nm exciter line and 20 mW laser power input to the fibre. The electromagnetic radiation emitted by the laser was then focused within the core of the probe by means of a 10× NA=0.25 lens of an Olympus® microscope. The probe was kept coaxial with the lens and at a suitable distance therefrom by a suitable support connected to the microscope sample-holder which had x, y and z adjustability with micrometric movements.

The probe was then immersed in a 1*10⁻⁷M (moles/litre) test solution of Crystal Violet in distilled water and the radiation scattered was collected by the Dilor XY® Raman spectrometer with an accumulation time of 10 seconds.

When an immersion period of one minute had elapsed, the tip was removed and the radiation scattered with the tip removed was collected by the Dilor XY® Raman spectrometer at various times after removal, with accumulation times of 10 seconds.

### EXAMPLE 14

### Detection of the Thiophenol Molecule in Gaseous Phase by Means of the Probe of Example 2H

The end of the probe remote from that coated in accordance with Example 2H was cut to produce a cross-section with a perpendicular parallel to the axis of the fibre. The probe was then connected to a Toptica Photonics® EXTRA® laser with a 785 nm exciter line and about 20 mW laser-beam power input to the optical fibre. The electromagnetic radiation emitted by the laser was then focused within the core of the probe by means of a 10× NA=0.25 lens of an Olympus® BX41 microscope. The probe was kept coaxial with the lens and at a suitable distance therefrom by a suitable support connected to the microscope sample-holder which had x, y and z adjustability with micrometric movements.

The optical fibre sensor as produced in Example 2H was then arranged in a container with a volume of 2 dm³. A solution containing 1 part of thiophenol and 10⁹ parts of ethanol (by volume) was then prepared. 0.1 ml of this solution was withdrawn and placed in the 2 dm³ container which was hermetically sealed. After complete evaporation of the solution, if necessary by slight heating of the container, the thiophenol concentration was determined. The thiophenol concentration in the container was about 0.0125 ppb (parts per billion).

About 10 minutes after complete evaporation of the solution, a measurement was taken with an accumulation time of 15 seconds with the use of a Labram HR800® Raman spectrometer.

The spectrum acquired contained the Raman bands typical of thiophenol at about 1000, 1023, 1073 and 1574 cm⁻¹.

### EXAMPLE 15

### Detection of the Thiophenol Molecule in Gaseous Phase by Means of the Probe of Example 2H

The end of the probe remote from that coated in accordance with Example 2H was cut to produce a cross-section with a perpendicular parallel to the axis of the fibre. The probe was then connected to a Toptica Photonics® EXTRA® laser with a 785 nm exciter line and about 20 mW laser-beam power input to the optical fibre. The electromagnetic radiation emitted by the laser was then focused within the core of the probe by means of a 10× NA=0.25 lens of an Olympus® BX41 microscope. The probe was kept coaxial with the lens and at a suitable distance therefrom by a suitable support connected to the microscope sample-holder which had x, y and z adjustability with micrometric movements.

The optical fibre sensor as produced in Example 2H was then arranged in a container with a volume of 2 dm³. A solution containing 1 part of thiophenol and 10⁶ parts of ethanol (by volume) was then prepared. 0.1 ml of this solution was withdrawn and placed in the 2 dm³ container which was hermetically sealed. After complete evaporation of the solution, if necessary by slight heating of the container, the concentration of thiophenol in the container was determined and corresponded to about 12.5 ppb (parts per billion).

About 10 minutes after complete evaporation of the solution, a measurement was taken with an accumulation time of 15 seconds with the use of a Labram HR800® Raman spectrometer.

The spectrum acquired contained the Raman bands typical of thiophenol at about 1000, 1023, 1073 and 1574 cm⁻¹.

### EXAMPLE 16

### Detection of the Thiophenol Molecule in Gaseous Phase by Means of the Probe of Example 2H

The end of the probe remote from that coated in accordance with Example 2H was cut to produce a cross-section with a perpendicular parallel to the axis of the fibre. The probe was then connected to a Toptica Photonics® EXTRA® laser with a 785 nm exciter line and about 20 mW laser-beam power input to the optical fibre. The electromagnetic radiation emitted by the laser was then focused within the core of the probe by means of a 10× NA=0.25 lens of an Olympus® BX41 microscope. The probe was kept coaxial with the lens and at a suitable distance therefrom by a suitable support connected to the microscope sample-holder which had x, y and z adjustability with micrometric movements.

The optical fibre sensor as produced in Example 2H was then arranged in a container of 2 dm³ volume. A solution containing 1 part of thiophenol and 1000 parts of ethanol (by volume) was then prepared. 0.1 ml of this solution was withdrawn and placed in the 2 dm³ container which was hermetically sealed. After complete evaporation of the solution, if necessary by slight heating of the container, the concentration of thiophenol in the container was determined and was about 12.5 ppm (parts per million).

About 10 minutes after complete evaporation of the solution, a measurement was taken with an accumulation time of 15 seconds with the use of a Labram HR800® Raman spectrometer.

The spectrum acquired contained the Raman bands typical of thiophenol at about 1000, 1023, 1073 and 1574 cm⁻¹.

By utilizing the SERS effect, the probe according to the invention, coupled with a laser and a Raman spectrometer, thus has greater sensitivity than sensors of the prior art and a high degree of selectivity in the recognition of some molecules that are more SERS-active than others. It also gives rise to a response almost in real time, even when connected to a portable spectrometer.

It can therefore detect concentrations even of the order of 10⁻⁸M, but it is thought that it will also succeed in detecting concentrations down to 10⁻¹²M, particularly with the use of an initial pre-concentration step, where possible, prior to measurement.

The probe has been used here for the detection of SERS-active substances dissolved in liquid, but the probe can also detect substances in gaseous phase. In gaseous phase, the probe can advantageously detect concentrations in parts per thousand, parts per million, and down to concentrations of less than parts per billion.

The probe according to the invention can also be used in all fields which require a quantitative analysis of very low quantities such as, for example, in environmental analysis to determine substances in industrial discharges, in biology to determine nitrogenous bases, or even in medicine and in anti-doping tests. In fact, it is possible to calculate the concentration of a solution of unknown concentration from the intensity/area of the Raman bands recorded, after calibration of the probe in question. Calibration can be achieved by measuring and plotting in a graph the intensity/area of a reference band as a function of the concentration (known beforehand) of some test solutions. Once the calibration curve has been obtained, the concentration of the molecule can be derived from the area/intensity of the band. For the series of measurements used for the calibration curve, the probe is preferably subjected to a washing operation with suitable solvents or solutions having appropriate pH ranges between one measurement and another.

The invention has been described with reference to some preferred embodiments by way of non-limiting example but may undergo modifications or additions without departing from the scope of the appended claims.

1. An optical probe (1) for detecting SERS-active molecules, which probe can transmit incident electromagnetic radiation at a predetermined wavelength and comprises a core (2) of cross-section S and a shell (3), wherein such a core (2) in turn comprises:
a first tapered portion (4), and
a second portion (5) having substantially constant cross-section s and length l,
wherein the second portion (5) is connected to the first tapered portion (4) and is covered at least partially by a coating (7) of SERS active metallic material, the said first portion (4) and the remaining part of the second portion (5) being covered with a coating (7′) of an at least partially reflective metallic material, and wherein
the cross-section s of the said second portion (5) is in the range of from 10⁻⁸*S to 0.99*S and the length l of the second portion is in the range of from 0.01*√S to 10⁵*√S.

2. The optical probe (1) according to claim 1 wherein the cross-section s of the second portion is between 10⁻⁶*S and 0.9*S, preferably between 10⁻⁴*S and 0.3*S.

3. The optical probe (1) according to claim 1 or claim 2 wherein the length l of the second portion is between 0.1√S and 10⁴*√S, preferably between √S and 10³*√S.

4. The optical probe (1) according to any one of claims 1 to 3 wherein the optical probe comprises a core (2) made of silica (SiO₂) and a shell (3) of silica (SiO₂) or, alternatively, a shell (3) of polymer material and a silica core (2), or even a core (2) and a shell (3) both of polymer material.

5. The optical probe (1) according to any one of claims 1 to 4 wherein the coating (7) is made of a SERS-active metallic material selected from the group consisting of silver, gold, copper and platinum.

6. The optical probe (1) according to claim 5 wherein the SERS-active metallic material is silver or gold.

7. The optical probe (1) according to claim 5 or claim 6 wherein the metallic material is in the form of metal nano-particles and the coating (7) is a coating of metal nano-particles.

8. The optical probe (1) according to claim 7 wherein the coating (7) is a coating of metal nano-particles dispersed in a polyvinyl alcohol film.

9. The probe (1) according to claim 7 or claim 8 wherein the metallic material in nano-particle form is silver.

10. The optical probe (1) according to any one of claims 1 to 9 wherein the metallic coating (7′) of at least partially reflective metallic material is a coating of aluminium or even of a metal selected from the group consisting of silver, gold, copper and platinum, applied as a coating having a thickness of at least 100 nm.

11. The optical probe (2) according to any one of claims 1 to 9 wherein the metallic coating (7′) of partially reflective metallic material is a coating of SERS-active metallic material.

12. The optical probe (1) according to any one of claims 1 to 11 wherein the probe (1) comprises a third tapered portion (6), the second portion (5) of substantially constant cross-section s connecting the first tapered portion (4) and the third tapered portion (6), and wherein the coating (7′) of at least partially reflective metallic material is also applied to the third tapered portion (6).

13. The optical probe (1) according to claim 12 wherein the coating (7′) of at least partially reflective metallic material applied to the third tapered portion (6) is at least partially a coating of SERS-active metallic material.

14. The optical probe (1) according to claim 12 wherein the coating (7′) of at least partially reflective metallic material applied to the third tapered portion (6) is a coating of SERS-active metallic material.

15. The optical probe (1) according to any one of claims 1 to 14 wherein the coating (7) of SERS-active metallic material is functionalized with a functionalizing layer.

16. A process for manufacturing a probe (1) according to claim 11 comprising the following steps:
a) immersing a part of an optical fibre comprising a core (2) in a solution comprising an upper solvent phase (8) and a lower etching phase (9), so that the said part of the fibre is immersed below the interface (10) between the upper phase (8) and the lower phase (9);
b) keeping the optical fibre below the said interface (10) until a cross-section s of the immersed part of the fibre is reached by chemical etching performed by the lower etching phase (9);
c) raising a desired length l of the fibre above the interface (10); and
d) applying a coating of SERS-active metallic material to the parts that were subjected to chemical etching in step b).

17. A process for manufacturing a probe (1) according to claim 14, comprising the following steps:
a) immersing a part of an optical fibre comprising a core (2) in a solution comprising an upper solvent phase 8 and a lower etching phase 9 so that the said part of the fibre is below the interface (10) between the upper phase (8) and the lower phase (9);
b) keeping the optical fibre below the interface 10 until a cross-section s of the immersed part of the fibre is reached by chemical etching performed by the lower etching phase 9;
c) raising a desired length l of the fibre above the interface (10) whilst keeping the end part of the fibre below the interface (10) between the upper phase (8) and the lower phase (9) so that the said end part is subjected to chemical etching by the lower etching phase 9; and
d) applying a coating of SERS-active metallic material to the parts that were subjected to chemical etching treatment in steps b) and c).

18. The process according to claim 17 comprising a further step e) consisting in eliminating the end part of the fibre that was treated with the lower etching phase (9) in step c).

19. The process according to any one of claims 16 and 18 or any one of claims 17 and 18 wherein the fibre is preferably a fibre in which the core (2) is made of SiO₂.

20. The process according to any one of claims 16 and 18-19 or any one of claims 17-19 wherein the fibre also comprises a shell (3) made of silica, or a shell (3) of polymer material which is removed beforehand from the part of the fibre that will be immersed in the lower etching phase (9).

21. The process according to claim 19 or claim 20 wherein the lower etching phase (9) is an acid phase.

22. The process according to claim 21 wherein the upper solvent phase is any solvent that is substantially immiscible with and of a lower density than the lower, acid phase (9).

23. The process according to claim 22 wherein the solvent is preferably selected from the group consisting of iso-octane, p-xylene, m-xylene, dodecyl mercaptan (dodecanethiol), octane, toluene, 1-chloro-octane, dibutyl sulphide, dibutyl ether.

24. The process according to any one of claims 16 and 18-23 or any one of claims 17-23 wherein the coating application step d) is performed by application by vacuum plating with the use of a solution of a salt of the metal and subsequent heating or by application of a layer of nano-particles.

25. The process according to claim 24 wherein the coating application step d) takes place by the formation of a layer of nano-particles by means of a colloidal metal solution and immobilization with an immobilizing agent.

26. The process according to claim 25 wherein the immobilizing agent is (3-aminopropyl)-trimethoxysilane or (3-mercaptopropyl)-trimethoxysilane.

27. The process according to claim 24 wherein the coating of metal nano-particles is applied by means of a colloidal solution of metal nano-particles and polyvinyl alcohol.

28. The process according to any one of claims 16 and 18-27 or any one of claims 17-27 wherein the coating application step d) is performed immediately before or during use in the detection and/or measurement of SERS-active molecules.

29. Use of a probe (1) according to any one of claims 1 to 15 wherein the probe (1) is connected to a laser device and to a Raman spectrometer for the detection and/or measurement of SERS-active molecules in liquid phase and in gaseous phase.

30. Use according to claim 29 wherein the SERS-active molecules are organic, inorganic or metallic substances in gaseous phase or in liquid phase.

31. Use according to claim 29 wherein the probe detects SERS-active molecules in liquid phase in concentrations of less than 10⁻⁶M.

32. Use according to claim 29 wherein the probe detects SERS-active molecules in gaseous phase in concentrations of from parts per million (ppm) to parts per billion (ppb).

33. Use according to claim 29 wherein the SERS-active molecules are selected from the group consisting of nitrogenous bases, neurotransmitters, antibiotics, fungicides, herbicides, cyanides, doping substances, explosive substances, weed-killers, dyes, fertilizers, aromatic compounds, compounds with n bonds, proteins, medicaments, and amino-acids.
